(19) United States
(12) Patent Application Publication
(10) Pub. No.: US 2023/0239447 A1
(43) Pub. Date: Jul. 27, 2023

(54) SMART WEARABLE DEVICE FOR VISION ENHANCEMENT AND METHOD FOR REALIZING STEREOSCOPIC VISION TRANSPOSITION

(71) Applicants: Jianming Song, Shenzhen (CN); Tieshan Zhang, Shenzhen (CN); Jie Hu, Shenzhen (CN)

(72) Inventors: Jianming Song, Shenzhen (CN); Tieshan Zhang, Shenzhen (CN); Jie Hu, Shenzhen (CN)

(21) Appl. No.: 17/667,527

(22) Filed: Feb. 8, 2022

(30) Foreign Application Priority Data
Jan. 22, 2022 (CN) 202210077914.2

(51) Int. Cl. H04N 13/122; H04N 5/225; H04N 5/243; H04N 13/344; G02B 27/01

(52) U.S. Cl. CPC H04N 13/122; G02B 27/0172; G02B 27/0176; H04N 5/243; H04N 5/2254; H04N 5/2257; H04N 13/344; G02B 30/34; G02B 2027/014; G02B 2027/0134; G02B 2027/0138; G02B 2027/0159

(57) ABSTRACT

The invent discloses a smart wearable device for vision enhancement and a method for realizing stereoscopic vision transposition, comprising a wearable device body, wherein the wearable device body is provided with camera lenses, image sensors, an image information receiving and transmitting unit, image enhancement units, and near-to-eye optical systems; the optical axis and field angle of the near-to-eye optical system are matched with the optical axis and field angle of the camera lens; the image sensor is arranged behind the camera lens; the real scene enters the image sensor through an image imaging device for image acquisition, and through the image enhancement unit, the low-light environment image collected by the smart wearable device in the low-light environment is enhanced and displayed clearly. The invention can ensure the enhancement of the real stereoscopic vision in the dark environment and the interchange of the remote and barrier-free stereoscopic real vision.

### BACKGROUND OF THE INVENTION

### 1. Field of the Invention

The invention belongs to the application field of smart digital network technology, relates to the application of image acquisition, visual enhancement and visual transposition, and in particular relates to a smart wearable device for vision enhancement and a method for realizing stereoscopic vision transposition.

### 2. Description of the Related Art

In modern life, people sometimes need to observe objects from a distance, or occasionally want to travel but cannot do it for various reasons. By applying the smart wearable device of the invention, only when one person uploads the video of the sightseeing tour, the visual exchange can be realized, and the beautiful scenery can be seen without leaving home;

In the prior art, there are only wearable devices capable of virtual reality, and it is far from being able to make users feel immersed and experience in person.

### SUMMARY OF THE INVENTION

The technical problem to be solved by the invention is to provide a smart wearable device for vision enhancement and a method for realizing stereoscopic vision transposition; more than one camera lens is respectively provided on both sides of the smart wearable device, and image sensors are respectively provided behind the camera lens; one or two sets of near-to-eye optical systems are provided on both sides of the smart wearable device in front of the human eyes; this optical system allows the human eyes to see the displayed image and also see the real external environment image through the system; the field angle of the camera lens on the single side is matched with the field angle of the near-to-eye optical system, and the ratio of the field angle is doubled or other magnifications; the camera lens on the single side images the real scene onto the image sensor through the real object light; after the image sensor collects the real scene image in the dark environment, the virtual scene is displayed through the near-to-eye optical system corresponding to one side; the observer can see the enhanced scene corresponding to the real scene by observing the virtual scene displayed by the near-to-eye optical system; when more than one set of visual enhancement systems work on the same real scene, by adjusting the appropriate optical axis angle, the stereoscopic visual enhancement effect can be obtained.

The invention is realized by the following technical solutions: a smart wearable device for vision enhancement, comprising a wearable device body, wherein the wearable device body is provided with camera lenses, image sensors, an image information receiving and transmitting unit, image enhancement units, and near-to-eye optical systems; the optical axis and field angle of the near-to-eye optical system are matched with the optical axis and field angle of the camera lens; the image sensor is arranged behind the camera lens; the real scene enters the image sensor through an image imaging device for image acquisition, and through the image enhancement unit, the low-light environment image collected by the smart wearable device in the low-light environment is enhanced and displayed clearly.

Preferably, each set of the near-to-eye optical systems comprises an optical system that overlaps and transmits a near-to-eye display screen and the image, so that the virtual scene formed after enhancement processing can be displayed on the display screen;

the image displayed on the near-to-eye display screen is projected to the human eyes through the near-to-eye optical system, and the ambient object light image is simultaneously transmitted to the human eyes through the near-to-eye optical system to realize the overlapping display of the external environment and the virtual image.

Preferably, the near-to-eye optical system is correspondingly provided with an interocular distance adjusting device; the optical axis distance between the two near-to-eye optical systems can be increased or decreased by the interocular distance adjusting device, so that the optical axis distance is matched with the interocular distance of the observer.

Preferably, a diopter adjustment device is further provided between the near-to-eye display screen and the near-to-eye optical system, which is used to increase or decrease the axial distance between the near-to-eye display screen and the near-to-eye optical system, so as to adjust the diopter of the near-to-eye optical system.

The wearable device body is divided into an image acquisition end device and an image reproduction end device; the device parameter configuration of the image acquisition end device and the image reproduction end device is matched to realize the interchangeable use between the image acquisition end device and the image reproduction end device; through the transmission and copying of image information, one image acquisition end corresponds to multiple image reproduction ends;
the specific steps are as follows:
   S1: the real scene enters the image sensor through an image imaging device for image acquisition;
   S2: the collected image enters the image enhancement unit for image enhancement processing;
   S3: image storage or transmission after enhancement by the image enhancement unit;
   S4: the enhanced image is simultaneously imported into the image display screen of the near-to-eye optical system for image display;
   S5: after the enhanced image is displayed by the near-to-eye optical system, using the diopter adjustment device located between the near-to-eye display screen and the near-to-eye optical system can adjust the axial distance between the near-to-eye display screen and the near-to-eye optical system, so as to adjust, namely, increase or decrease the diopter of the near-to-eye optical system;
   S6: at the same time, the interocular distance adjustment device between the two sets of the near-to-eye optical systems can be used to increase or decrease the optical axis distance between the two sets of the near-to-eye optical systems, so that the optical axis distance is the same as the interocular distance of the human eyes to achieve the effect of adjusting the interocular distance;
   S7: the image processed by the action of the above device is clearly mapped on the display screen designed in each set of the near-to-eye optical systems, so that the virtual scene formed after enhancement processing is projected into the eyes of the observer, and the observer can see the scene that cannot be seen originally when using the device to realize the visual enhancement function;
   S8: after the image collected by the image acquisition device is subjected to image enhancement and channel processing, the image is transmitted to the image reproduction end device through the information storage or transmission device;
   S9: after receiving the image information, the reproduction end displays the images collected by the acquisition end to the corresponding near-to-eye optical system as a virtual scene, so as to be observed by the human eyes; the observer can feel the enhanced scene by the enhanced object light, so as to realize the visual transposition technology effect of the real three-dimensional reproduction of the remote scene.

Preferably, for the information storage and output device of the image acquisition end device, the information channel stored or output is that each signal is independently transmitted as a channel or multiple signals are combined into a channel for transmission or storage, and the information it outputs or stores to the image reproduction end device is separated and reproduced correspondingly.

Preferably, the transmission device is designed into wired transmission or wireless transmission; during transmission, transmitting each image data channel separately, or combining each channel into one channel for transmission, and ensuring that the image reproduction end separates each channel and reproduces it on the corresponding display channel.

The advantageous effects of the invention are: in the invention, the real scene enters the camera lens through the real object light, and is imaged on the respective image sensor through the camera lens; the image information collected by the sensor is used for storage and transmission, and the stored file can ensure that the corresponding near-to-eye optical system can display the image separately when it is reproduced and displayed; the information transmission can be separate transmission for each channel of information, or multiple channels of information can be combined for one transmission, but both can ensure that the corresponding near-to-eye optical system can display images separately when reproducing and displaying; the way of image information transmission can be file copying, wireless transmission, wired transmission and so on. After receiving the image information, the reproduction end displays the images collected by the acquisition end to the corresponding near-to-eye optical system as a virtual scene for the human eyes to observe. The observer can feel the enhanced scene by the enhanced object light, so as to realize the visual transposition technology effect of the real three-dimensional reproduction of the remote scene.

### BRIEF DESCRIPTION OF THE DRAWINGS

In order to more clearly illustrate the embodiments of the invention or the technical solutions in the prior art, the drawings that need to be used in the description of the embodiments or the prior art will be briefly introduced hereinafter. Obviously, the drawings in the following description are only some embodiments of the invention. For those of ordinary skill in the art, other drawings can also be obtained from these drawings without creative effort.

FIG. 1 is a use state diagram of the wearable device according to the invention;

FIG. 2 is a structural schematic diagram of the working part of the wearable device according to the invention;

FIG. 3 is a schematic structural diagram of the near-to-eye optical system and the near-to-eye display screen according to the invention;

FIG. 4 is a schematic diagram of the technical application method of the visual image transposition transmission of the smart wearable device according to the invention;

FIG. 5 is a schematic diagram of the technical application workflow of image acquisition, visual enhancement and stereoscopic vision transposition of the smart wearable device according to the invention;

FIG. 6 is schematic diagram of the overall structure according to the invention.

### DETAILED DESCRIPTION OF THE PREFFERED EMBODIMENTS

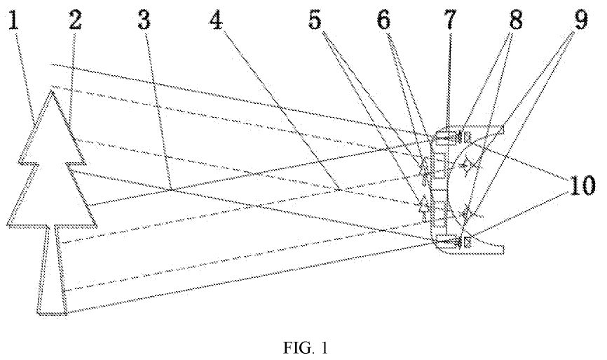

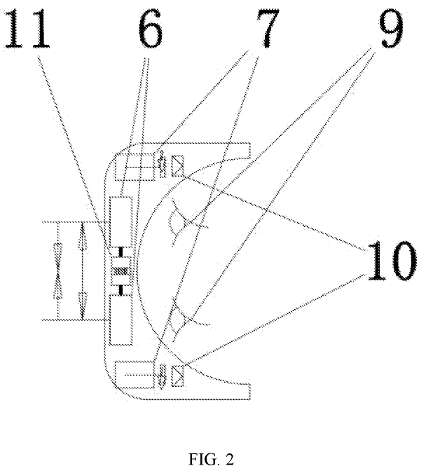

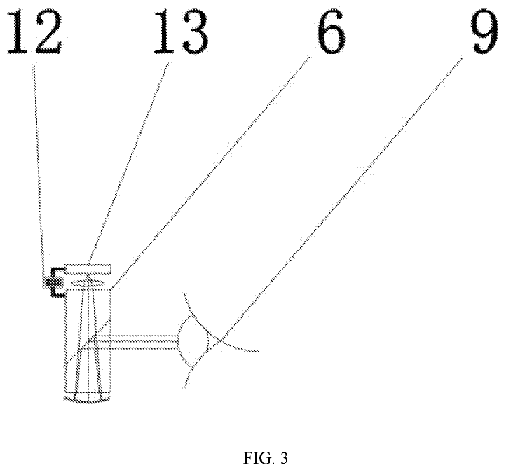

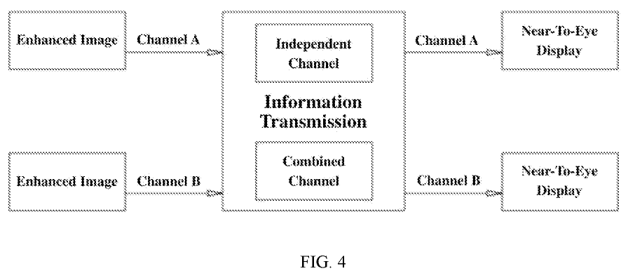

As shown in FIGS. 1-3, a smart wearable device for vision enhancement, comprising a wearable device body, wherein the wearable device body is provided with camera lenses 7, image sensors 8, an image information receiving and transmitting unit, image enhancement units 10, and near-to-eye optical systems 6; the optical axis and field angle of the near-to-eye optical system 6 are matched with the optical axis and field angle of the camera lens 7; the image sensor is arranged behind the camera lens 7; the real scene 1 enters the image sensor 8 through an image imaging device for image acquisition, and through the image enhancement unit 10, the low-light environment image collected by the smart wearable device in the low-light environment is enhanced and displayed clearly;
the wearable device is further provided with an image storage and transmission device; the transmission or storage method of the image can be that each acquisition channel is separated, or each channel can be combined into one channel for processing; as shown in FIG. 4, the output or stored information can be separated and reproduced correspondingly to the image reproduction end;
the image enhancement unit of the smart wearable device enables the observer to clearly see the enhanced scene 2 in the low-light environment, where the low-light environment images that are otherwise invisible or unclear to human eyes can be enhanced;
in the wearable device of the invention, a near-to-eye display screen 13 is designed in each set of the near-to-eye optical systems, so that the virtual scene formed after enhancement processing can be displayed on the display screen and projected into the eyes of the observer;
in the wearable device of the invention, the near-to-eye optical system is correspondingly provided with an interocular distance adjusting device 11; the optical axis distance between the two near-to-eye optical systems can be increased or decreased by this device, so that the optical axis distance is the same as the interocular distance of the human eyes;
in the wearable device of the invention, a diopter adjustment device 12 is further provided between the near-to-eye display screen and the near-to-eye optical system, which is used to increase or decrease the axial distance between the near-to-eye display screen and the near-to-eye optical system, so as to adjust, namely, increase or decrease the diopter of the near-to-eye optical system to match the individual differences in the user’s diopter;
the parameter configuration of the acquisition end and the reproduction end of the wearable device is matched, so the acquisition end and the reproduction end are completely interchangeable;
through the transmission and copying of image information, one acquisition end can correspond to multiple reproduction ends.

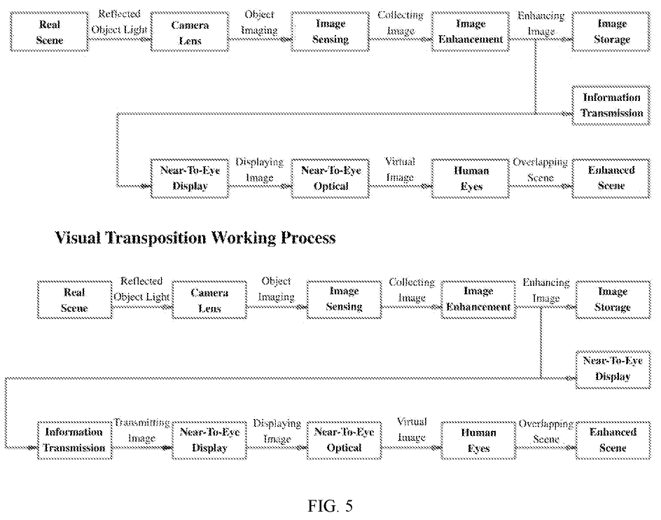

As shown in FIG. 5, the working process of image acquisition and visual enhancement is as follows:

the object light reflected by the real scene passes through the camera lens of the image acquisition device, and enters the image sensor device under the action of the object imaging of the camera lens; the image sensor imports the collected image into the image enhancement unit, and enters the image storage device or the image information transmission device 13 after the enhancement effect of the image enhancement unit; the enhanced image obtained by the image enhancement unit is imported into the near-to-eye display screen; after the enhanced image is displayed by the near-to-eye optical system, using the diopter adjustment device located between the near-to-eye display screen and the near-to-eye optical system can adjust the axial distance between the near-to-eye display screen and the near-to-eye optical system, so as to adjust, namely, increase or decrease the diopter of the near-to-eye optical system; at the same time, the interocular distance adjustment device between the two sets of the near-to-eye optical systems can be used to increase or decrease the optical axis distance between the two sets of the near-to-eye optical systems, so that the optical axis distance is the same as the interocular distance of the human eyes 9 to achieve the effect of adjusting the interocular distance; the image processed by the action of the above device is clearly mapped on the display screen designed in each set of the near-to-eye optical systems, so that the virtual scene formed after enhancement processing is projected into the eyes of the observer.

Transmission of image information:

the device acquisition end transmits the enhanced image from the independent image data channel or the combined image data channel to the image information receiving unit of the device reproduction end through wired or wireless transmission of the transmission device; after receiving the enhanced image information, the image information receiving unit separates the image information transmission channel and imports it into the display channel corresponding to the transmission; the image information receiving unit imports the image information corresponding to the display channel into the image enhancement unit 10, and imports it into the near-to-eye display screen after the enhanced image obtained; after the enhanced image is displayed by the near-to-eye optical system, using the diopter adjustment device located between the near-to-eye display screen and the near-to-eye optical system can adjust the axial distance between the near-to-eye display screen and the near-to-eye optical system, so as to adjust, namely, increase or decrease the diopter of the near-to-eye optical system; at the same time, the interocular distance adjustment device between the two sets of the near-to-eye optical systems can be used to increase or decrease the optical axis distance between the two sets of the near-to-eye optical systems, so that the optical axis distance is the same as the interocular distance of the human eyes to achieve the effect of adjusting the interocular distance; the image processed by the action of the above device is clearly mapped on the display screen designed in each set of the near-to-eye optical systems, so that the virtual scene formed after enhancement processing is projected into the eyes of the observer.

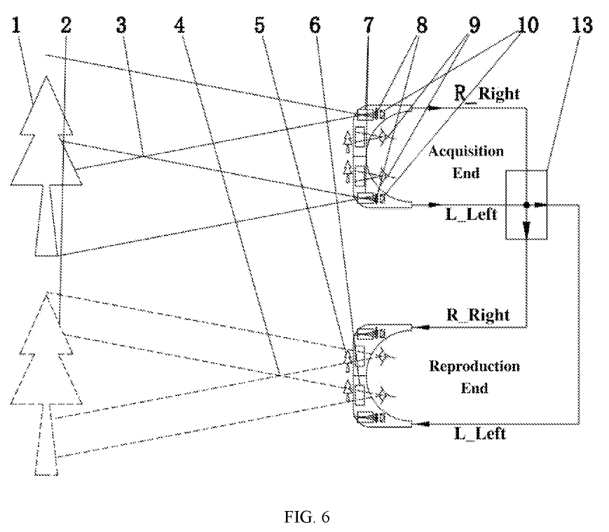

As shown in FIG. 6, the realization method of stereoscopic vision transposition of image information is as follows:

the parameter configuration of the acquisition end and the reproduction end of the device is consistent, so that the functions of the acquisition end and the reproduction end are completely interchangeable, that is, the above transmission path can be from the acquisition end to the reproduction end, or from the reproduction end to the acquisition end; at this time, the function of the acquisition end becomes the function of the reproduction end, and the function of the reproduction end changes to the function of the acquisition end;

After receiving the image information, the reproduction end displays the images collected by the acquisition end to the corresponding near-to-eye optical system as a virtual scene 5 for the human eyes to observe. The observer can feel the enhanced scene 2 by the enhanced object light 4, so as to realize the visual transposition technology effect of the real three-dimensional reproduction of the remote scene.

Combined with the image acquisition and visual enhancement, and the image information transmission method of the above smart wearable device, the transmission path of the image information is changed, and the image information is enhanced and transmitted; through the transmission and copying functions of the image information of the device, one collection end can correspond to multiple reproduction ends, thereby realizing the visual transposition of the smart wearable device, so that the virtual scene formed after enhancement processing can be projected into the eyes of the observer.

The invention allows the observer to see the displayed image and also see the real external environment image through the system; the field angle of the camera lens on the single side is matched with the field angle of the near-to-eye optical system, and the ratio of the field angle is doubled or other magnifications; the camera lens on the single side images the real scene onto the image sensor through the real object light 3; after the image sensor collects the real scene image in the dark environment, the virtual scene is displayed through the near-to-eye optical system corresponding to one side; the observer can see the enhanced scene corresponding to the real scene by observing the virtual scene displayed by the near-to-eye optical system; when more than one set of visual enhancement systems work on the same real scene, by adjusting the appropriate optical axis angle, the stereoscopic visual enhancement effect can be achieved.

The above are only specific embodiments of the invention, but the protection scope of the invention is not limited thereto, and any modifications or substitutions that are not thought of creative work shall all fall within the protection scope of the invention. Therefore, the protection scope of the invention should be based on the protection scope defined by the claims.

1. A smart wearable device for vision enhancement, comprising a wearable device body, wherein the wearable device body is provided with camera lenses, image sensors, an image information receiving and transmitting unit, image enhancement units, and near-to-eye optical systems; the optical axis and field angle of the near-to-eye optical system are matched with the optical axis and field angle of the camera lens; the image sensor is arranged behind the camera lens; the real scene enters the image sensor through an image imaging device for image acquisition, and through the image enhancement unit, the low-light environment image collected by the smart wearable device in the low-light environment is enhanced and displayed clearly.

2. The smart wearable device for vision enhancement according to claim 1, wherein each set of the near-to-eye optical systems comprises an optical system that overlaps and transmits a near-to-eye display screen and the image, so that the virtual scene formed after enhancement processing can be displayed on the display screen;
the image displayed on the near-to-eye display screen is projected to the human eyes through the near-to-eye optical system, and the ambient object light image is simultaneously transmitted to the human eyes through the near-to-eye optical system to realize the superposition display of the external environment and the virtual image.

3. The smart wearable device for vision enhancement according to claim 1, wherein the near-to-eye optical system is correspondingly provided with an interocular distance adjusting device; the optical axis distance between the two near-to-eye optical systems can be increased or decreased by the interocular distance adjusting device, so that the optical axis distance is matched with the interocular distance of the observer.

4. The smart wearable device for vision enhancement according to claim 2, wherein a diopter adjustment device is further provided between the near-to-eye display screen and the near-to-eye optical system, which is used to increase or decrease the axial distance between the near-to-eye display screen and the near-to-eye optical system, so as to adjust the diopter of the near-to-eye optical system.

5. A method for realizing stereoscopic vision transposition by the smart wearable device for vision enhancement, wherein the wearable device body is divided into an image acquisition end device and an image reproduction end device; the device parameter configuration of the image acquisition end device and the image reproduction end device is matched to realize the interchangeable use between the image acquisition end device and the image reproduction end device; through the transmission and copying of image information, one image acquisition end corresponds to multiple image reproduction ends;
the specific steps are as follows:
S1: the real scene enters the image sensor through an image imaging device for image acquisition;
S2: the collected image enters the image enhancement unit for image enhancement processing;
S3: image storage or transmission after enhancement by the image enhancement unit;
S4: the enhanced image is simultaneously imported into the image display screen of the near-to-eye optical system for image display;
S5: after the enhanced image is displayed by the near-to-eye optical system, using the diopter adjustment device located between the near-to-eye display screen and the near-to-eye optical system can adjust the axial distance between the near-to-eye display screen and the near-to-eye optical system, so as to adjust, namely, increase or decrease the diopter of the near-to-eye optical system;
S6: at the same time, the interocular distance adjustment device between the two sets of the near-to-eye optical systems can be used to increase or decrease the optical axis distance between the two sets of the near-to-eye optical systems, so that the optical axis distance is the same as the interocular distance of the human eyes to achieve the effect of adjusting the interocular distance;
S7: the image processed by the action of the above device is clearly mapped on the display screen designed in each set of the near-to-eye optical systems, so that the virtual scene formed after enhancement processing is projected into the eyes of the observer, and the observer can see the scene that cannot be seen originally when using the device to realize the visual enhancement function;
S8: after the image collected by the image acquisition device is subjected to image enhancement and channel processing, the image is transmitted to the image reproduction end device through the information storage or transmission device;
S9: after receiving the image information, the reproduction end displays the images collected by the acquisition end to the corresponding near-to-eye optical system as a virtual scene, so as to be observed by the human eyes; the observer can feel the enhanced scene by the enhanced object light, so as to realize the visual transposition technology effect of the real three-dimensional reproduction of the remote scene.

6. The method for realizing stereoscopic vision transposition by the smart wearable device for vision enhancement according to claim 5, wherein for the information storage and output device of the image acquisition end device, the information channel stored or output is that each signal is independently transmitted as a channel or multiple signals are combined into a channel for transmission or storage, and the information it outputs or stores to the image reproduction end device is separated and reproduced correspondingly.

7. The method for realizing stereoscopic vision transposition by the smart wearable device for vision enhancement according to claim 5, wherein the transmission device is designed into wired transmission or wireless transmission; during transmission, transmitting each image data channel separately, or combining each channel into one channel for transmission, and ensuring that the image reproduction end separates each channel and reproduces it on the corresponding display channel.
